(19) United States
(12) Patent Application Publication
(10) Pub. No.: US 2011/0131213 A1
(43) Pub. Date: Jun. 2, 2011

(54) Apparatus and Method for Mining Comment Terms in Documents

(75) Inventors: Yu-Chieh Wu, Tucheng City (TW); Pei-Sen Liu, Yonghe City (TW); Han-Shiang Chang, Taipei City (TW); Sheng-Ho Chang, Taiping City (TW); Hsin-Jung Huang, Taipei City (TW)

(73) Assignee: INSTITUTE FOR INFORMATION INDUSTRY, Taipei (TW)

(21) Appl. No.: 12/748,681

(22) Filed: Mar. 29, 2010

(30) Foreign Application Priority Data
Nov. 30, 2009 (TW) 98140850

(51) Int. Cl. G06F 17/30

(52) U.S. Cl. 707/741; 707/736; 707/780; 707/E17.002; 707/E17.044

(57) ABSTRACT

This invention discloses a method for mining a comment term in a document. The method comprises, first, to build a document database and a keyword database, wherein the document database includes at least one digital document, the keyword database includes at least one keyword. Then, a language of the digital document is determined. The digital document is processed based on the language to form a first document. Next, word groups are gathered from the first document based on a gathering range and apart-of-speech, wherein each word group includes the keyword and a word with the part-of-speech.

### RELATED APPLICATIONS

This application claims priority to Taiwan Application Serial Number 98140850 filed Nov. 30, 2009, which is herein incorporated for reference.

### BACKGROUND

1. Field of Invention

The present invention relates to an apparatus and a method for analyzing a document. More particularly, the present invention relates to an apparatus and a method for analyzing comment terms in a document.

2. Description of Related Art

The Internet development has brought the development of users to deliver usage comments of products in the Internet. Therefore, it is an important work for producer to understand what usage comment is delivered in the Internet. A typical method used by the producer is to hire Market Inspectors to collect these comments in the Internet. However, such method costs producers a high cost. Moreover, because the comment collection is made by a market inspector, it is very difficult to require the market inspector to pursue the comment of this product for a long time when the market inspector is responsible for many products at the same time.

Therefore, an apparatus and method that can solve the foregoing problems are required.

### SUMMARY

This invention discloses a method for mining a comment term in a document. The method comprises, first, to build a document database and a keyword database, wherein the document database includes at least one digital document, the keyword database includes at least one keyword. Then, a language of the digital document is determined. The digital document is processed based on the language to form a first document. Next, word groups are gathered from the first document based on a gathering range and apart-of-speech, wherein each word group includes the keyword and a word with the part-of-speech.

In an embodiment, the gathering range is a number of sentence before or after the keyword in the first document or is a number of word before or after the keyword in the first document.

In an embodiment, the part-of-speech is selected from the group consisting of an adjective word, a noun word, an objective word, an adverb word and a combination thereof.

In an embodiment, further comprising to arrange the word groups based on a number of the word groups presented in the digital document; and gather words groups whose number is larger than a threshold number.

In an embodiment, further comprising to perform a correlation measure to get a correlation value between the keyword and the word of a word group of the words groups whose number is larger than a threshold number and gather word groups whose correlation value is larger than a threshold value, wherein the correlation measure is a Conditional Probability measure, Mutual Information measure or a reliability measure.

In an embodiment, further comprising to build an INDEX table that records sources and data of the digital document and to refer the digital document to the source and data based on the INDEX table.

This invention discloses a method for mining a comment term in a document. The method comprises, first, to build a document database and a keyword database, wherein the document database includes at least one digital document, the keyword database includes at least one keyword. Then, a language of the digital document is determined. The digital document is processed based on the language to form a first document. Next, a first word groups are gathered from the first document based on a gathering range and apart-of-speech, wherein each word group includes the keyword and a word with the part-of-speech. Next, the first word groups are arranged based on a number of each word group of the first word groups presented in the digital document. A second words groups whose number is larger than a threshold number from the first word groups. A correlation measure is performed to get a correlation value between the keyword and the word of each word group in the second words groups. Then, a third word groups whose correlation value is larger than a threshold value is gathered from the second word groups.

The present invention further provides an apparatus for mining a comment term in a document. The apparatus comprises a document database, a keyword database, a language determination module, a part-of-speech processing module, a filtering module, a correlation measure module and a display module. The document database includes at least one digital document. The keyword database includes at least one keyword. The language determination module determines a language of the digital document. The part-of-speech processing module processes the digital document based on the language to form a first document. The filtering module gathers a first word groups from the first document based on a gathering range and a part-of-speech. Each word group of the first word groups includes the keyword and a word with the part-of-speech. The first word groups are arranged based on a number of each word group of the first word groups presented in the digital document. The filtering module gathers a second words groups from the first word groups whose number is larger than a threshold number. The correlation measure module performs a correlation measure to get a correlation value between the keyword and the word of a word group of the second words groups, wherein a third word groups whose correlation value is larger than a threshold value is gathered from the second word groups. The display module displays the third word groups.

In an embodiment, this apparatus further comprises an INDEX building module to build an INDEX table that records sources and data of the digital document.

In an embodiment, the part-of-speech processing module further comprises a segmentation process unit for segmenting a document to sentences and segmenting the sentences to words; and a part-of-speech tagging process unit for tagging part-of-speech of each word.

As aforementioned, the present invention has the following advantages. The present invention can automatically collect the usage evaluation from other customers. Therefore, a customer can make an exact decision before he buys a product based on this evaluation. A producer can improve his product based on this evaluation. A competitor can develop a next generation product based on this evaluation.

### BRIEF DESCRIPTION OF THE DRAWINGS

The invention can be more fully understood by reading the following detailed description of the embodiments, with reference made to the accompanying drawings as follows:

FIG. 1 illustrates a flow chart for mining a comment term in a document according to an embodiment of the present invention.

FIG. 2 illustrates an apparatus for mining comment terms in a document according to an embodiment of the present invention.

FIG. 3 illustrates an example for mining comment terms in a document according to an embodiment of the present invention.

FIG. 4 illustrates an example for mining comment terms in a document according to an embodiment of the present invention.

### DETAILED DESCRIPTION

According to the present invention, first, word segmentation process and part-of-speech tagging process are applied to process documents. Then, all words that are located in defined gathering range around the defined production name and match defined part-of-speech are gathered. The gathered words and the product name are grouped. Next, a correlation measure is applied to each group to get a correlation value between the gathered word and the product name in this group. The correlation value is compared with a defined threshold value to select the group with a correlation value larger than the threshold value. The detailed process is described in the following.

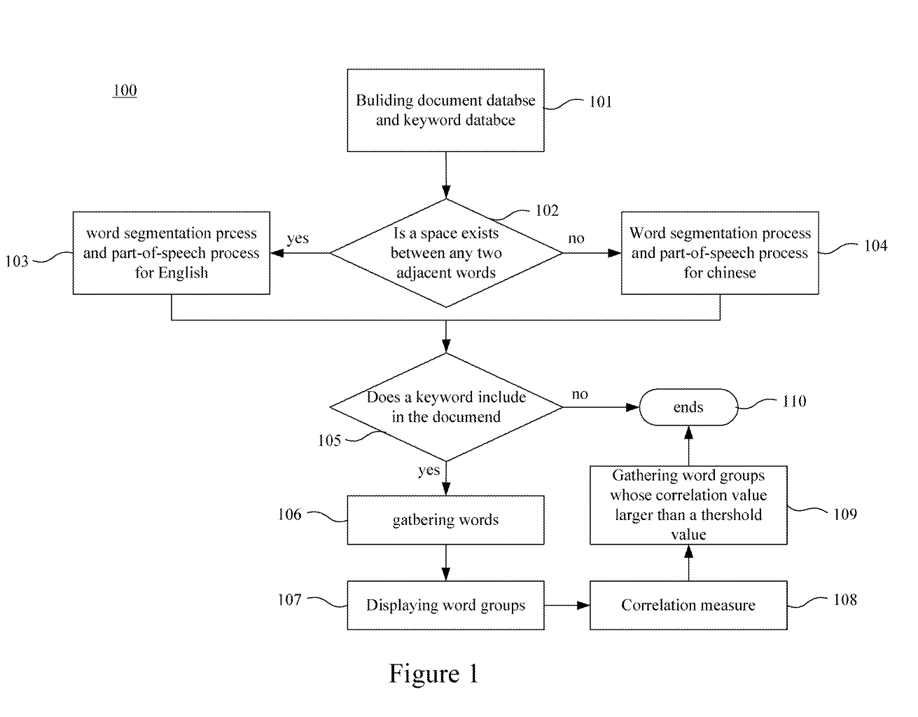

FIG. 1 illustrates a flow chart for mining a comment term in a document according to an embodiment of the present invention.

In step 101 of the process 100, document database and keyword database are built. The document database includes many kinds of digital documents collected from the Internet, such as collected from BBS, Discussion, Blog. An INDEX about these documents is built. This INDEX records the source and data that documents are collected and the location that words locate in corresponding documents. The keyword database stores the keywords for mining. In an embodiment, the keywords are the product names.

In step 102, a determination step is processed to determine whether or not a space exists between two words. In an embodiment, a Chinese document or an English document is determined by detecting whether or not a space exists between any two adjacent words. A document written by English can be segmented to words based on whether a space exists between two adjacent words. That is, as long as a space exists between any two adjacent words in a document, this document is an English document. Then, in step 103, word segmentation process and part-of-speech tagging process for English are applied to process this English document.

On the other hand, should no space exist between any two words, this document is a Chinese document. Then, in step 104, word segmentation process and part-of-speech tagging process for Chinese are applied to process this Chinese document. The word segmentation process is to segment a document to sentences. Then, these sentences are segmented to words. The part-of-speech tagging process is to tag part-of-speech of each word. It is noticed that the present invention also can be used to analyze other language documents.

In step 105, a determination process is performed to determine whether or not any keyword is included in these documents. In an embodiment, when a product comment is searched, the keyword is the product name. Accordingly, words gathered from these documents are compared with the keywords stored in the keyword database to determine whether or not these documents are related to the product. When words gathered from a document do not match the keywords stored in the keyword database, this document is not related to this product. That is, this document does not have any comment for this product. Then, step 110 is performed to end this process 100.

On the other hand, when words gathered from a document match the keywords stored in the keyword database, this document is related to this product. That is, this document has comment for this product. Then, step 106 is performed to gather additional words from this document.

In step 106, additional words are gathered based on a defined rule. The defined rule includes to set a product name, a part-of-speech of gathered word and gathering range. Based on this rule, step 106 can gather the words that are located around the product name and in the gathering range and whose part-of-speech match the required part-of speech. Each of the gathered words and the product name is grouped together to form a word group.

In an embodiment, the gathering range is one sentence before or after this product name. The part-of-speech of the gathered word is an adjective. In this embodiment, based on this rule, the words that locate in one sentence before or after the product name and are an adjective are gathered. Each of the gathered words and the product name is grouped together to form a word group.

Moreover, in another embodiment, the gathering range is five words before or after this product name. Such gathering range can prevent to search out a word that is totally not related to the product. Because one sentence can have many adjective words to describe different noun words, it is possible to search out an adjective word located in the gathering range, one sentence, but not related to the set product name. Therefore, in this embodiment, five words gathering range is set to prevent the foregoing case.

Moreover, in another embodiment, an additional part-of-speech of the gathered word is set. For example, the set part-of-speech of the gathered words is selected from the group consisting of an adjective word, a noun word, an objective word, an adverb word and a combination thereof.

Next, in step 107, all gathered word groups are displayed to a user, wherein same word group is not repeatedly displayed. The number of same word group presented in documents is accumulated. In an embodiment, a threshold number is set to exclude the word groups whose number presented in documents less than the threshold number.

Moreover, in step 108, a correlation measure is applied to each group to get a correlation value between the gathered word and the product name in this group. This step is to prevent the case that the gathered word is totally not related to the product. For example, the gathered adjective word is to describe food. However, the product is about a mobile-phone. The gathered word is not related to the product. In an embodiment, the correlation measure is, such as, a Conditional Probability measure, Mutual Information measure, or reliability measure.

In step 109, the word group that has the highest correlation value is gathered. In an embodiment, a threshold value is set. The correlation value is compared with the set threshold value to select the word group with a correlation value larger than the threshold value. Then, step 110 is performed to end this process 100. At this time, a user can evaluate the product based on the gathered word group.

In another embodiment, the gathered word group is referred to the document database again. Based on the built INDEX, the gathered word group can connect to the corresponding document. Therefore, the source and the data that the word group is issued can be pursued. That is, an evaluation trend for the product from the customer can be formed. When the evaluation trend is trending up, the designer can know that the product design matches the user requirement. On the other hand, when the evaluation trend is trending down, the designer can know that the product design does not match the user requirement.

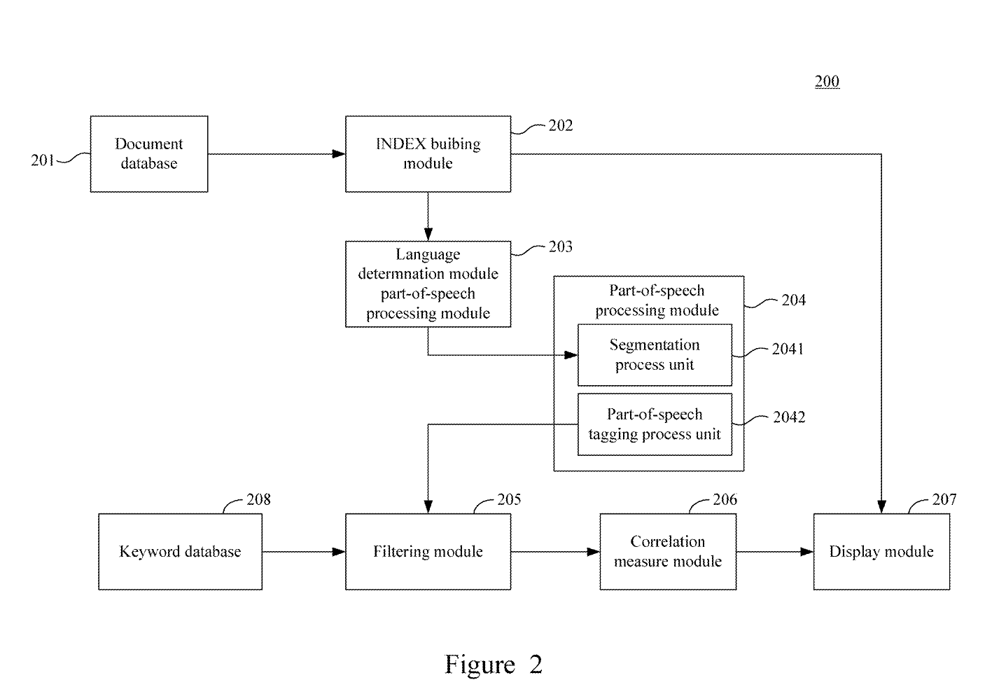

FIG. 2 illustrates an apparatus for mining comment terms in a document according to an embodiment of the present invention. The apparatus 200 includes a document database 201, an INDEX building module 202, a language determination module 203, a part-of-speech processing module 204, a filtering module 205, a correlation measure module 206, a display module 207 and a keyword database 208.

The document database 201 includes many kinds of digital documents collected from the Internet, such as collected from BBS, Discussion, Blog. The INDEX building module 202 builds an INDEX about these documents. This INDEX records the source and data that documents are collected and the location that words locate in corresponding document. The keyword database 208 stores the keywords for mining. In an embodiment, the keywords are the product names for mining comment terms of products in documents stored in the document database 201.

The language determination module 203 determines a document language. In an embodiment, a Chinese document or an English document is determined by detecting whether or not a space exists between any two adjacent words. Therefore, the language determination module 203 determines whether or not a space exists between two adjacent words. A document written by English can be segmented to words based on whether spaces exist between two adjacent words. That is, as long as a space exists between any two adjacent words in a document, this document is an English document. On the other hand, should no space exist between any two adjacent words, this document is a Chinese document.

The part-of-speech processing module 204 processes this document based on its language determined by the language determination module 203. The part-of-speech processing module 204 further comprises a segmentation process unit 2041 and part-of-speech tagging process unit 2042. The segmentation process unit 2041 segments a document to sentences. Then, these sentences are segmented to words. The part-of-speech tagging process unit 2042 tags part-of-speech of each word.

The filtering module 205 gathers words based on a defined rule. The defined rule includes to set a product name, a part-of-speech of gathered word and gathering range. Based on this rule, The filtering module 205 can gather the words that are located around the product name and in the gathering range and whose part-of-speech match the required part-of speech. Each of the gathered words and the product name is grouped together to form a word group.

In an embodiment, the gathering range is one sentence before or after this product name. The part-of-speech of the gathered word is an adjective. In this embodiment, based on this rule, the words that locate in one sentence before or after the product name and are an adjective are gathered by the filtering module 205.

Moreover, in another embodiment, the gathering range is five words before or after this product name. Such gathering range can prevent to search out a word that is totally not related to the product. Because one sentence can have many adjective words to describe different noun words, it is possible to search out an adjective word located in the gathering range, one sentence, but not related to the set product name. Therefore, in this embodiment, five words gathering range is set to prevent the foregoing case.

Moreover, in another embodiment, an additional part-of-speech of the gathered word is set. For example, the set part-of-speech of the gathered words is selected from the group consisting of an adjective word, a noun word, an objective word, an adverb word and a combination thereof. The filtering module 205 can gather corresponding words based on the defined rule. Each of the gathered words and the product name is grouped together to form a word group. The number of same word group presented in documents is accumulated. In an embodiment, a threshold number is set to exclude the word groups whose number presented in documents less than the threshold number.

The correlation measure module 206 is applied to each group gathered by the filtering module 205 to get a correlation value between the gathered word and the product name in this group. This is to prevent the case that the gathered word is totally not related to the product. For example, the gathered adjective word is to describe food. However, the product is about a mobile-phone. The gathered word is not related to the product. In an embodiment, the correlation measure is, such as, a Conditional Probability measure, Mutual Information measure, or reliability measure. In an embodiment, a threshold value is set. The correlation value is compared with the set threshold value to select the word group with a correlation value larger than the threshold value.

The display module 207 displays the word groups to a user. The user can base on the mining word group to evaluate the product. Moreover, the word groups can be referred to the document database 201 again. Based on the built INDEX by the INDEX building module 202, the word groups can connect to the corresponding documents. The display module 207 can display corresponding documents to the user. Therefore, the source and the data that the word groups are issued can be pursued. That is, an evaluation trend for the product from the customer can be formed. When the evaluation trend is trending up, the designer can know that the product design matches the user requirement. On the other hand, when the evaluation trend is trending down, the designer can know that the product design does not match the user requirement.

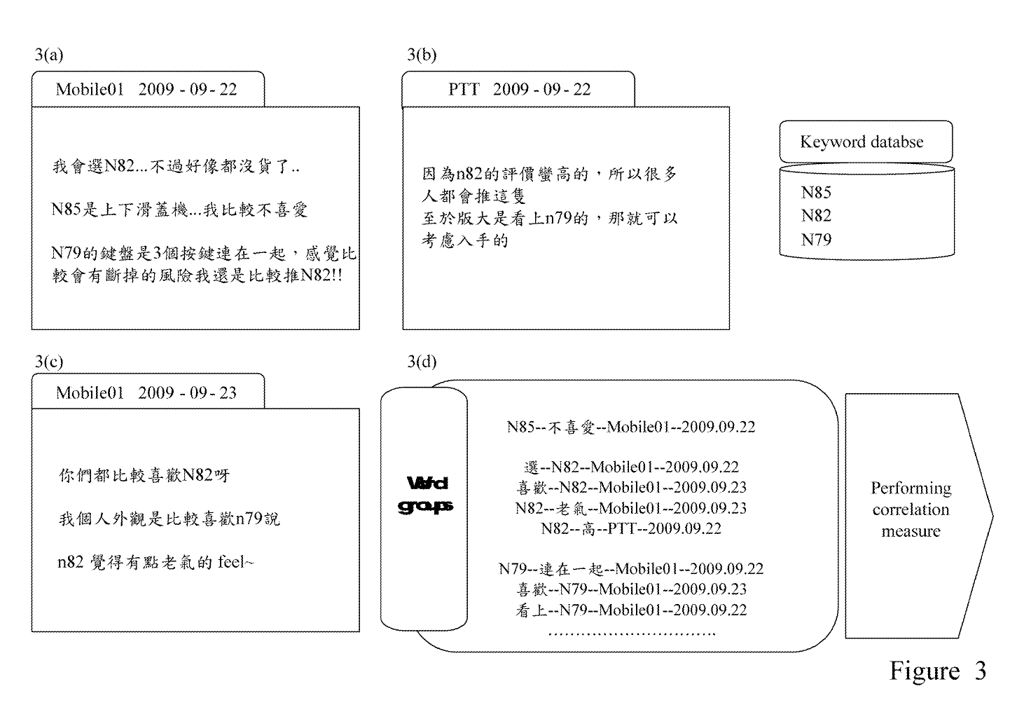

FIG. 3 illustrates an example for mining comment terms in a document according to an embodiment of the present invention. In this example, comment terms in Chinese documents are mined. FIG. 1 to FIG. 3 are referred.

Three documents are in the document database 210. The source and data of the three documents are as follows:

3(a): The document is collected from website, Mobile01, and at 2009/09/22.

3(b): The document is collected from website, Mobile01, and at 2009/09/23.

3(c): The document is collected from website, Mobile01, and at 2009/09/22.

Three keywords, N85, N82 and N97, are stored in the keyword database 208. The keywords, N85, N82 and N97, are product names of a NOKIA mobile phone.

The gathering range is five words before or after this product name. The part-of-speech of the gathered word is an adjective. The threshold value is 10%. That is, only the word group whose number presented in documents is 10% prior among all word groups are selected. Moreover, a correlation measure, Mutual Information measure, is applied to each word group to get a correlation value. The set threshold value is 70%. Therefore, only the word group with a correlation value larger than 70% is selected.

The mining result is displayed in 3(d).

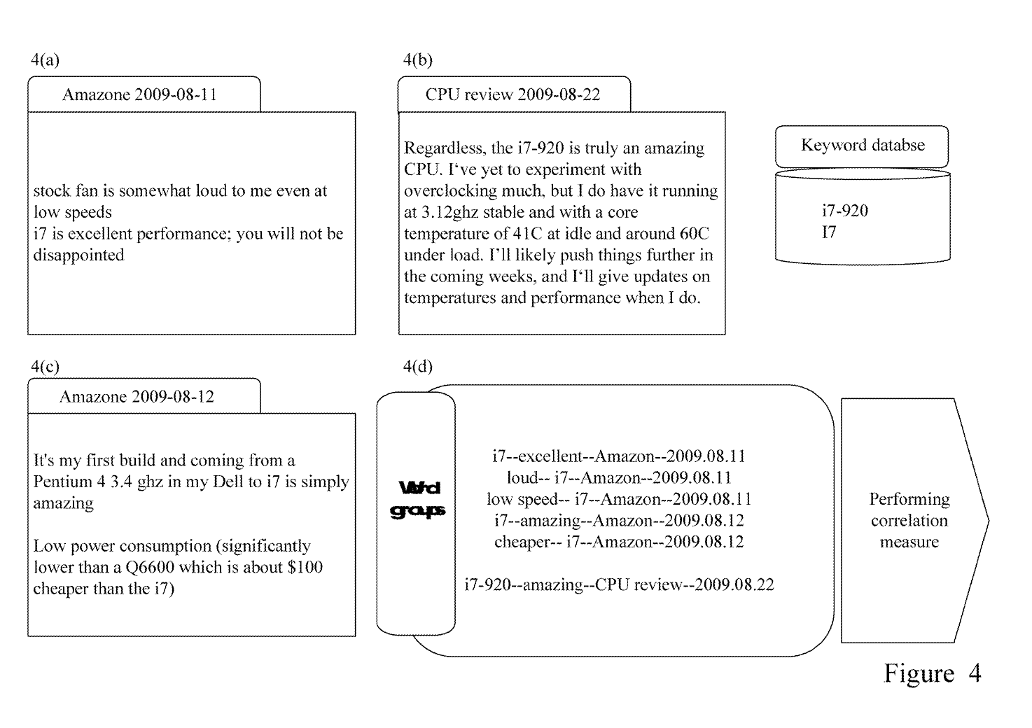

FIG. 4 illustrates an example for mining comment terms in a document according to an embodiment of the present invention. In this example, comment terms in English documents are mined. FIG. 1 to FIG. 3 are referred.

Three documents are in the document database 210. The source and data of the three documents are as follows:

4(a): The document is collected from website, Amazone, and at 2009/08/22.

4(b): The document is collected from website, Amazone, and at 2009/08/12.

4(c): The document is collected from website, CPU review, and at 2009/08/22.

Three keywords, I-7 and i7-920, are stored in the keyword database 208. The keywords, I-7 and i7-920, are product names of a CPU.

The gathering range is two sentences before or after this product name.

The part-of-speech of the gathered word is an adjective. The threshold value is 20%. That is, only the word group whose number presented in documents is 20% prior among all word groups are selected. Moreover, a correlation measure, Mutual Information measure, is applied to each word group to get a correlation value. The set threshold value is 70%. Therefore, only the word group with a correlation value larger than 70% is selected.

The mining result is displayed in 4(d). Only the word group whose number presented in documents is 20% prior among all word groups are displayed.

i7 - - - excellent - - - Amazon - - - 2009.08.11

loud - - - i7 - - - Amazon - - - 2009.08.11

low speed - - - i7 - - - Amazon - - - 2009.08.11

i7 - - - amazing - - - Amazon - - - 2009.08.12

cheaper - - - i7 - - - Amazon - - - 2009.08.12

i7-920 - - - amazing - - - CPU review - - - 2009.08.22

For example, the word group, i7—amazing, is gathered form the sentence, It's my first build and coming from a Pentium 4 3.4 ghz in my Dell to i7 is simply amazing”, of the document in 4(c). Based on this rule, the product name is i7. The present invention gathers the words that are located around the product name, i7, and in the gathering range, “five words”, and whose part-of-speech match the required part-of speech, adjective. Therefore, the word, “amazing”, is gathered. Therefore, the word group, i7—amazing, is formed.

Then, the Mutual Information measure, is applied to each word group to get a correlation value. The set threshold value is 70%.

Accordingly, the present invention has the following advantages. The present invention can automatically collect the usage evaluation from other customers. Therefore, a customer can make an exact decision before he buys a product based on this evaluation. A producer can improve his product based on this evaluation. A competitor can develop a next generation product based on this evaluation.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for mining a comment term in a document, comprising:
building a document database and a keyword database, wherein the document database includes at least one digital document, the keyword database includes at least one keyword;
determining a language of the digital document;
processing the digital document based on the language to form a first document;
receiving a gathering range and a part-of-speech;
gathering word groups from the first document based on the gathering range and the part-of-speech, wherein each word group includes the keyword and a word with the part-of-speech.

2. The method for mining a comment term in a document of claim 1, wherein the gathering range is a number of sentence before or after the keyword in the first document.

3. The method for mining a comment term in a document of claim 1, wherein the gathering range is a number of word before or after the keyword in the first document.

4. The method for mining a comment term in a document of claim 1, wherein the part-of-speech is selected from the group consisting of an adjective word, a noun word, an objective word, an adverb word and a combination thereof.

5. The method for mining a comment term in a document of claim 1, wherein determining a language of the digital document further comprises:
determining whether or not a spaces exists between two adjacent words.

6. The method for mining a comment term in a document of claim 1, wherein processing the digital document based on the language further comprises:
segmenting a document to sentences;
segmenting the sentences to words; and
tagging part-of-speech of each word.

7. The method for mining a comment term in a document of claim 1, further comprising:
determining the keyword whether or not exists in the first document;
ending the method when the keyword does not exist in the first document; and
gathering word groups from the first document when the keyword exists in the first document.

8. The method for mining a comment term in a document of claim 1, further comprising:
arranging the word groups based on a number of the word groups presented in the digital document; and
gathering words groups whose number is larger than a threshold number.

9. The method for mining a comment term in a document of claim 8, further comprising:
performing a correlation measure to get a correlation value between the keyword and the word of a word group of the words groups whose number is larger than a threshold number;
gathering word groups whose correlation value is larger than a threshold value.

10. The method for mining a comment term in a document of claim 9, wherein the correlation measure is a Conditional Probability measure, Mutual Information measure or a reliability measure.

11. The method for mining a comment term in a document of claim 9, further comprising to build an INDEX table that records sources and data of the digital document.

12. The method for mining a comment term in a document of claim 11, further comprising to refer the digital document to the source and data based on the INDEX table.

13. A method for mining a comment term in a document, comprising:
building a document database and a keyword database, wherein the document database includes at least one digital document, the keyword database includes at least one keyword;
determining a language of the digital document;
processing the digital document based on the language to form a first document;
receiving a gathering range and a part-of-speech;
gathering a first word groups from the first document based on the gathering range and the part-of-speech, wherein each word group of the first word groups includes the keyword and a word with the part-of-speech;
arranging the first word groups based on a number of each word group of the first word groups presented in the digital document; and
gathering a second words groups whose number is larger than a threshold number from the first word groups;
performing a correlation measure to get a correlation value between the keyword and the word of a word group of the second words groups; and
gathering a third word groups whose correlation value is larger than a threshold value from the second word groups.

14. The method for mining a comment term in a document of claim 13, wherein the gathering range is a number of sentence before or after the keyword in the first document.

15. The method for mining a comment term in a document of claim 13, wherein the gathering range is a number of word before or after the keyword in the first document.

16. The method for mining a comment term in a document of claim 13, wherein the part-of-speech is selected from the group consisting of an adjective word, a noun word, an objective word, an adverb word and a combination thereof.

17. The method for mining a comment term in a document of claim 13, wherein processing the digital document based on the language further comprises:
segmenting a document to sentences;
segmenting the sentences to words; and
tagging part-of-speech of each word.

18. The method for mining a comment term in a document of claim 13, further comprising:
determining whether or not the keyword exists in the first document;
ending the method when the keyword does not exist in the first document; and
gathering word groups from the first document when the keyword exists in the first document.

19. The method for mining a comment term in a document of claim 13, wherein the correlation measure is a Conditional Probability measure, Mutual Information measure or a reliability measure.

20. The method for mining a comment term in a document of claim 13, further comprising to build an INDEX table that records sources and data of the digital document.

21. The method for mining a comment term in a document of claim 20, further comprising to refer the digital document to the source and data based on the INDEX table.

22. An apparatus for mining a comment term in a document, comprising:
a document database, wherein the document database includes at least one digital document;
a keyword database, wherein the keyword database includes at least one keyword;
a language determination module for determining a language of the digital document;
a part-of-speech processing module for processing the digital document based on the language to form a first document;
a filtering module for gathering a first word groups from the first document based on a gathering range and a part-of-speech, wherein each word group of the first word groups includes the keyword and a word with the part-of-speech, and the first word groups are arranged based on a number of each word group of the first word groups presented in the digital document, wherein the filtering module gathers a second words groups from the first word groups whose number is larger than a threshold number;
a correlation measure module for performing a correlation measure to get a correlation value between the keyword and the word of a word group of the second words groups, wherein a third word groups whose correlation value is larger than a threshold value is gathered from the second word groups; and
a display module for displaying the third word groups.

23. The apparatus for mining a comment term in a document of claim 22, wherein the gathering range is a number of sentence before or after the keyword in the first document.

24. The apparatus for mining a comment term in a document of claim 22, wherein the gathering range is a number of word before or after the keyword in the first document.

25. The apparatus for mining a comment term in a document of claim 22, wherein the part-of-speech is selected from the group consisting of an adjective word, a noun word, an objective word, an adverb word and a combination thereof.

26. The apparatus for mining a comment term in a document of claim 22, wherein the part-of-speech processing module further comprises:
a segmentation process unit for segmenting a document to sentences and segmenting the sentences to words; and
a part-of-speech tagging process unit for tagging part-of-speech of each word.

27. The apparatus for mining a comment term in a document of claim 22, wherein the correlation measure is a Conditional Probability measure, Mutual Information measure or a reliability measure.

28. The apparatus for mining a comment term in a document of claim 13, further comprising an INDEX building module to build an INDEX table that records sources and data of the digital document.
